(19) United States
(12) Patent Application Publication
(10) Pub. No.: US 2008/0074691 A1
(43) Pub. Date: Mar. 27, 2008

(54) PRINT INFORMATION MANAGEMENT APPARATUS, PRINT INFORMATION MANAGEMENT METHOD, IMAGE FORMING APPARATUS, PRINT INFORMATION MANAGEMENT SYSTEM AND PROGRAM

(75) Inventor: Shusaku Kubo, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/681,315

(22) Filed: Mar. 2, 2007

(30) Foreign Application Priority Data
Sep. 25, 2006 (JP) P2006-258438

(51) Int. Cl. G06F 3/12

(52) U.S. Cl. 358/1.15; 358/1.16

(57) ABSTRACT

A print information management apparatus includes: a generation unit that generates print information in which identification information that uniquely specifies a medium on which a primary electronic document is printed is related to a secondary electronic document that can reproduce an image shape of the primary electronic document on the medium; and a storage unit that stores the print information generated by the generation unit.

### CROSS-REFERENCE TO RELATED APPLICATIONS

This application is based on and claims priority under 35 USC 119 from Japanese Patent Application No. 2006-258438 filed Sep. 25, 2006.

### BACKGROUND

1. Technical Field

The present invention relates to a print information management apparatus, an image forming apparatus, a print information management system, a print information management method, and a program.

### SUMMARY

According to an aspect of the invention, there is provided a print information management apparatus, which includes: a generation unit that generates print information in which identification information which uniquely specifies a medium on which a primary electronic document is printed is related to a secondary electronic document which can reproduce an image shape of the primary electronic document on the medium; and a storage unit that stores the print information generated by the generation unit.

### BRIEF DESCRIPTION OF THE DRAWINGS

Exemplary embodiments of the present invention will be described in detail based on the following figures, wherein:

FIG. 1 illustrates a diagram showing a system configuration to which an exemplary embodiment of the invention is applied;

FIG. 2 illustrates a diagram which explains the exemplary embodiment of the invention schematically;

FIG. 3 illustrates a block diagram showing the function and configuration of a server in a first exemplary embodiment of the invention;

FIG. 4 illustrates a flowchart showing an operation performed when printing is implemented on a medium in the first exemplary embodiment of the invention;

FIG. 5 illustrates a chart showing an example of management information generated in the exemplary embodiment of the invention;

FIGS. 6A and 6B illustrate diagrams which explain a code pattern generated in the exemplary embodiment of the invention;

FIG. 7 illustrates a diagram which explains the coding of information and generation of a coded image in the exemplary embodiment of the invention;

FIG. 8 illustrates a diagram showing the mechanism of an electronic pen in the exemplary embodiment of the invention;

FIG. 9 illustrates a flowchart showing the operation of the electronic pen in the exemplary embodiment of the invention;

FIG. 10 illustrates a flowchart showing an operation performed when writing is implemented on a medium in the first exemplary embodiment of the invention;

FIG. 11 illustrates a flowchart showing the function and configuration of an image forming apparatus in a second exemplary embodiment of the invention;

FIG. 12 illustrates a block diagram showing the function and configuration of a server in the second exemplary embodiment of the invention;

FIG. 13 illustrates a flowchart showing an operation performed when printing is implemented on a medium in the second exemplary embodiment of the invention;

FIG. 14 illustrates a flowchart showing an operation performed when scanning is implemented on a medium in the second exemplary embodiment of the invention; and

FIG. 15 illustrates a block diagram showing a hardware configuration of a computer which realizes the print information management unit in the exemplary embodiment of the invention.

### DETAILED DESCRIPTION

A best mode for carrying out the invention (hereinafter, referred to as an “exemplary embodiment”) will be described in detail below by reference to the accompanying drawings.

In the exemplary embodiment of the invention, in addition to a document image in which an electronic document, which is an object to be printed, (hereinafter, referred to as a “primary electronic document”) is imaged, a coded image is printed on a medium such as a sheet of paper. The coded image is an image in which an identification code and a position code which are obtained by coding identification information and position information are imaged. Here, the identification information is information which uniquely identifies a medium, and the position information is information which represents coordinates on the medium.

In addition, in the exemplary embodiment of the invention, when printing the primary electronic document, an electronic document which can reproduce an image shape of the primary electronic document (hereinafter, referred to as a “secondary electronic document”) is generated. In addition, management information is stored in which the identification information of the medium and the secondary electronic document are at least made equivalent to each other.

By this configuration, it becomes possible to obtain the secondary electronic document based on the identification information obtained by operating the medium.

In addition, although the word of “electronic document” is used in this specification, it is not just that the word means only data in which a “document” which includes texts is electronically processed. The “electronic document” is meant to include printable electronic data such as, for example, image data including pictures, photographs and graphic forms (it does not matter whether it is beta data or raster data), as well as numeric data that is recorded by a data base or spreadsheet software.

In addition, in the following description, for the sake for a simple description, identification information and position information are made clearly distinct from each other in use. However, there exists a method in which different position information is embedded in a coded image for each medium, so as to identify individual media by means of the position information so embedded. Then, in the event that such a method is adopted, understanding that the position information includes the function to identify a medium, the position information is to be considered as identification information.

Firstly, a system configuration of the exemplary embodiment will be described.

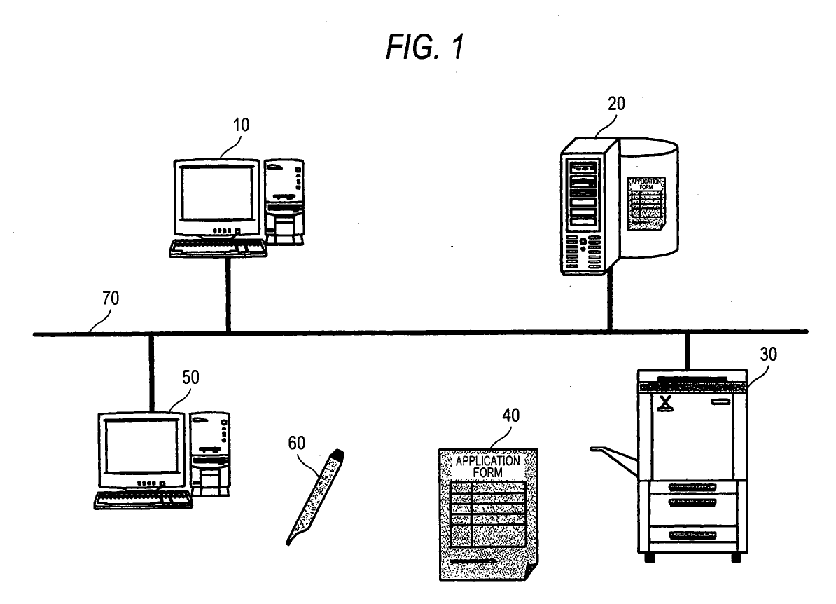

FIG. 1 is such as to show the configuration of a system to which the exemplary embodiment is applied.

As is shown in the figure, a system to which the exemplary embodiment is applied is made up of a client 10, a server 20, an image forming apparatus 30 and a client 50 which are all connected to a network 70. In addition, this system includes further a print document 40 and an electronic pen 60.

The client 10 is a computer which instructs the printing of a primary electronic document and is, for example, a PC (Personal Computer). Note that in this exemplary embodiment, as an example of an instruction unit that instructs the printing of the primary electronic document, the client 10 is adopted.

The server 20 is a computer which stores a medium, the primary electronic document and a secondary electronic document in such a state that the medium, the first electronic document and the secondary electronic document are related to each other, whereby when it receives identification information of the medium, the server 20 can provide the secondary electronic document based on the identification information so received. Note that in this exemplary embodiment, as an example of a print information management apparatus which manages print information, which will be described later on, the server 20 is adopted.

The image forming apparatus 30 forms an image on the medium. Here, as an image forming method adopted in the image forming apparatus 30, although for example, an electronic photographing method can be utilized, any other methods may be utilized.

The print document 40 is a document whose image is formed on the medium by the image forming apparatus 30.

The client 50 is a computer for transferring information from the electronic pen 60 to the server 20 and is, for example, a PC. Note that in this exemplary embodiment, as an example of an obtaining unit that obtains the secondary electronic document, the client 50 is adopted.

The electronic pen 60 is a pen device having a function to record characters or graphic forms on the print document 40. In addition, it has a function to transmit information obtained from the print document 40 to the client 50.

Next, a summary of the exemplary embodiment will be described.

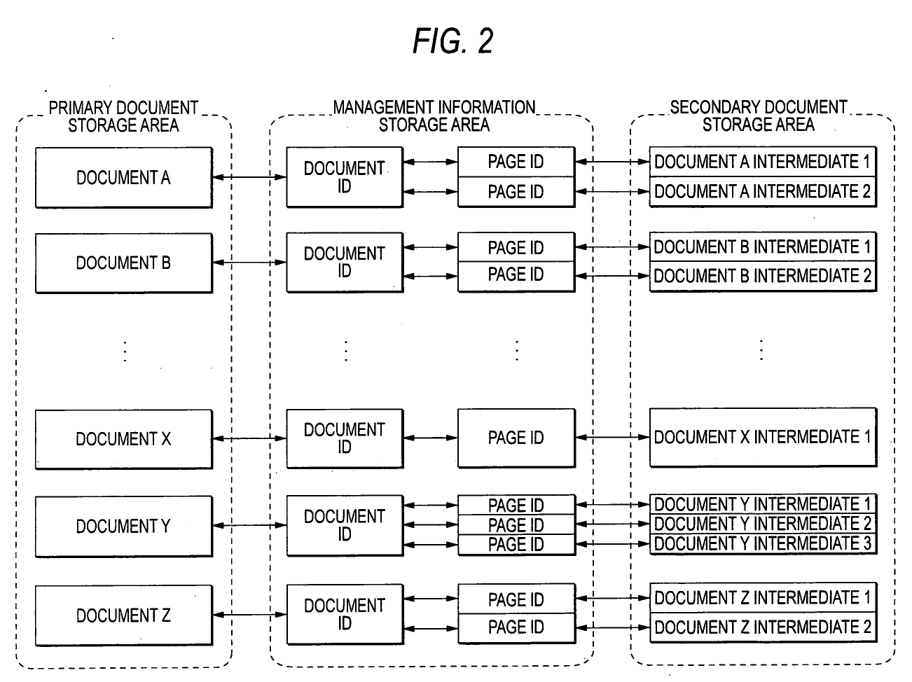

FIG. 2 is a diagram which shows a schematic configuration of the exemplary embodiment.

As is shown in the figure, the exemplary embodiment includes a primary document storage area for storing the primary electronic document and a secondary document storage area for storing the secondary electronic document which can reproduce an image shape of the primary electronic document. In addition, in the exemplary embodiment, the primary electronic document and the secondary electronic document are related to each other by means of a document ID and a page ID in a management information storage area. Here, the document ID is information for uniquely identifying the primary electronic document. In addition, the page ID is information for uniquely identifying a page on the print document 40 which carries the primary electronic document printed thereon.

The exemplary embodiment will be described specifically below using the example shown in FIG. 2.

As is shown in the figure, a document A, a document B, . . . , a document X, a document Y and a document Z are stored in the primary document storage area. Document IDs are allocated individually to those documents stored in such a manner that one document is designated by one document ID. Assume that the document A, the document B, . . . , the document X, the document Y and the document Z are printed in this state. In the case of FIG. 2, the document A and the document B are printed in two pages, respectively, the document X is printed in one page, the document Y is printed in three page and the document Z is printed in two pages. Then, page IDs are allocated to the individual printed pages in such a manner that one printed page is designated by one page ID and are stored in the management information storage area.

On the other hand, as this occurs, secondary electronic documents are stored in the secondary document storage area which can reproduce image shapes of the individual printed pages faithfully. Here, the image shape can include not only the shape of the image printed on the medium but also colors and the like, and hence, the image shape is such as to be referred to as a “print image” as well. In addition, the secondary electronic document is made to reproduce not only an image shape based on a normal print setting but also an image shape based on a special print setting such as an N-up designation (a designation to allocate N pages of an electronic document to one page of a medium) faithfully.

The reason the secondary electronic document is stored separately from the primary electronic document is that in the event that certain data in an electronic document is printed on a certain position on the print document 40, certain difficulty is entrained in linking the position on the print document 40 with the data in the electronic document. This is because although a printed document is outputted in such a manner as to be partitioned into pages, the electronic document is not such that it is managed in such a manner as to be partitioned into pages. For example, an electronic document which makes up a Web page does not originally have a concept of page. In addition, event though the electronic document has the concept of page, in the event that a change in layout occurs when printing, a corresponding relationship between a page of the electronic document and a page of the print document is collapsed.

In the exemplary embodiment, there may occur a case where the primary electronic document is referred to simply as a “document,” and the secondary electronic document is referred to as an “intermediate document.” Consequently, a first intermediate document of the document A is shown as a “document A intermediate 1,” and a second intermediate document of the document A is shown as a “document A intermediate 2.” Similarly, since an intermediate document corresponding to the document B has also a volume that is partitioned into two pages, the document B is also shown as a “document B intermediate 1,” and a “document B intermediate 2.” Furthermore, since an intermediate document corresponding to the document X has a volume equivalent to one page, the document X is shown as a “document X intermediate 1.” Furthermore, since an intermediate document corresponding to the document Y has a volume equivalent to three pages, the document Y is shown as a “document Y intermediate 1,” a “document Y intermediate 2,” and a “document Y intermediate 3.” In addition, since an intermediate document corresponding to the document Z has a volume equivalent to two pages, the document Z is shown as a “document Z intermediate 1,” and a “document Z intermediate 2.”

Then, these intermediate documents are managed in such a state that the documents are related to page IDs in such a manner that one intermediate document is designated by one page ID.

The exemplary embodiment will be described in greater detail below.

Incidentally, in this exemplary embodiment, various modes are considered from the viewpoints that which apparatuses making up the configuration of the system shown in FIG. 1 perform which functions such as to output an instruction to print a primary electronic document, to generate a secondary electronic document, and to store management information in which the medium, the primary electronic document and the secondary electronic document are related to each other. Here, attention is paid to three of them.

A first mode is such that the server 20 gives an instruction to the image forming apparatus 30 to print a primary electronic document in response to an instruction from the client 10, and the server 20 performs all functions to generate identification information of a medium, generate a secondary electronic document and store management information.

A second mode is such that when the client 10 gives an instruction to the image forming apparatus 30 to print a primary electronic document, the image forming apparatus 30 performs a function to generate identification information of a medium and a function to generate a secondary electronic document, and the server 20 scores management information and the secondary electronic document so generated.

A third mode is such that when the client 10 gives an instruction to the image forming apparatus 30 to print a primary electronic document, the client 10 performs a function to generate identification information of a medium and a function to generate a secondary electronic document, and the server 20 stores management information he secondary electronic document so generated.

Then, the first mode will be described as a first exemplary embodiment, the second mode as a second exemplary embodiment, and the third mode as a third exemplary embodiment.

Note that in the first exemplary embodiment, a case is assumed in which written data for a medium is added to a secondary electronic document. On the other hand, in the second exemplary embodiment, a case is assumed in which a secondary electronic document which corresponds to a medium which is scanned by the image forming apparatus 30 is displayed on a predetermined client. However, these utilization methods are only examples, and hence, the application of the secondary electronic document is limited by them.

### First Exemplary Embodiment

In this exemplary embodiment, as has been described above, the server 20 plays a main role in performing the processing.

Then, firstly, the function and configuration of the server 20 in this exemplary embodiment will be described.

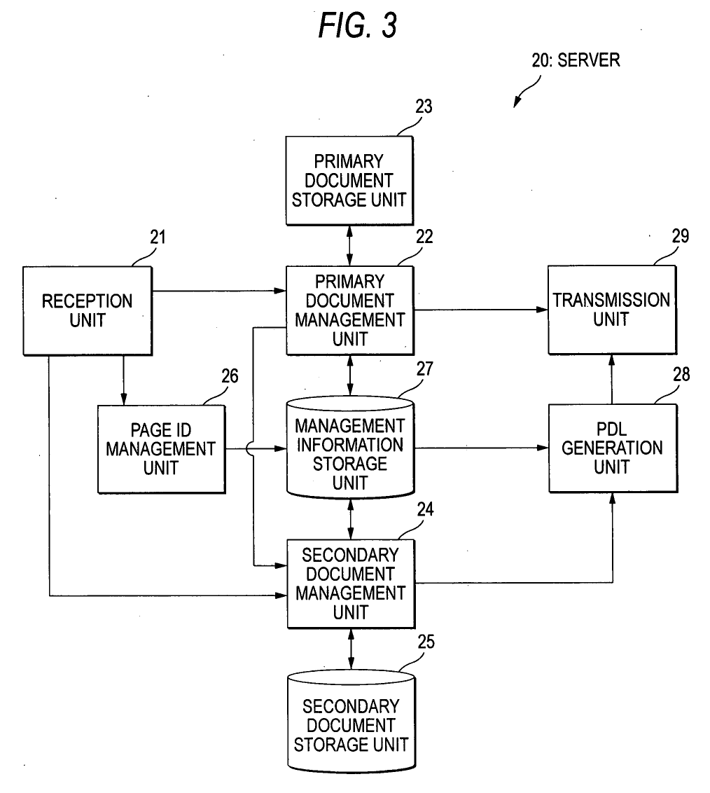

FIG. 3 is a diagram showing the function and configuration of the server 20.

As is shown in the figure, the server 20 includes a reception unit 21, a primary document management unit 22, a primary document storage unit 23, a secondary document management unit 24, a secondary document storage unit 25, a page ID management unit 26, a management information storage unit 27, a PDL generation unit 28 and a transmission unit 29.

The reception unit 21 receives from the client 10 instructions to enter a primary electronic document for registration and to print the same document and receives from the client 50 an instruction to transmit a secondary electronic document.

The primary document management unit 22 stores the primary electronic document in the primary document storage unit 23 in response to the instruction to register the primary electronic document and stores information such as a document ID or the like which identifies the primary electronic document in the management information storage unit 27. In addition, the primary document management unit 22 reads out the primary electronic document from the primary document storage unit 23 in response to the instruction to print the primary electronic document.

The primary document storage unit 23 corresponds to the primary document storage area in FIG. 2 and stores therein the primary electronic document.

The secondary document management unit 24 generates a secondary electronic document in response to the instruction to print the primary electronic document to store the secondary electronic document so generated in the secondary document storage unit 25 and stores information on such as a storage location of the secondary electronic document in the management information storage unit 27. In addition, the secondary document management unit 24 reads out the secondary electronic document from the secondary document storage unit 25 in response to the instruction to transmit the secondary electronic document. Note that in this exemplary embodiment, as an example of a processing unit that performs a process which enables the utilization of the secondary electronic document, the secondary document management unit 24 is adopted.

The secondary document storage unit 25 corresponds to the secondary document storage area in FIG. 2 and stores therein the secondary electronic document.

The page ID management unit 26 generates a page ID which identifies a page in the print document 40 in response to the instruction to print the primary electronic document and stores the page ID so generated in the management information storage unit 27.

The management information storage unit 27 corresponds to the management information storage area in FIG. 2 and stores therein management information in which the document ID, the page ID, a storage location of the primary electronic document, the storage location of the secondary electronic document and the like are made equivalent to each other. Note that in this exemplary embodiment, as an example of print information in which the identification information which identifies the medium, the secondary electronic document and the like are related to each other, this management information is adopted.

The PDL generation unit 28 generates a PDL (Page Description Language) for printing the primary electronic document.

The transmission unit 29 transmits the document ID back to the client 10 in response to the instruction to register the primary electronic document from the client 10. In addition, in response to the instruction to print the primary electronic document from the client 10, the transmission unit 29 transmits the PDL for the primary electronic document to the image forming apparatus 30. Furthermore, the transmission unit 29 transmits the secondary electronic document back to the client 50 in response to the instruction to transmit the secondary electronic document from the client 50.

In addition, in the exemplary embodiment, as an example of the generation unit that generates print information, a combination of the primary document management unit 22, the secondary document management unit 24 and the page ID management unit 26 is adopted.

Note that these functions are realized through cooperation between software and hardware resources. To be specific, a CPU of the server 20 reads out a program which realizes the reception unit 21, the primary document management unit 22, the secondary document management unit 24, the page ID management unit 26, the PDL generation unit 28, and the transmission unit 29 from, for example, a magnetic disk unit into a main memory and executes the program. In addition, the primary document storage unit 23, the secondary document storage unit 25 and the management information storage unit 27 can be realized using, for example, a magnetic disk unit. Furthermore, programs and data that are to be stored in the magnetic disk unit may be loaded from a recording medium such as a CD or downloaded via a network such as the internet.

Next, the operation of the system of the exemplary embodiment will be described.

Incidentally, the operation of the system of this exemplary embodiment is made up of an operation performed when printing is made on the medium and an operation performed when writing is made on the medium.

Then, firstly, the operation performed when printing is made on the medium will be described.

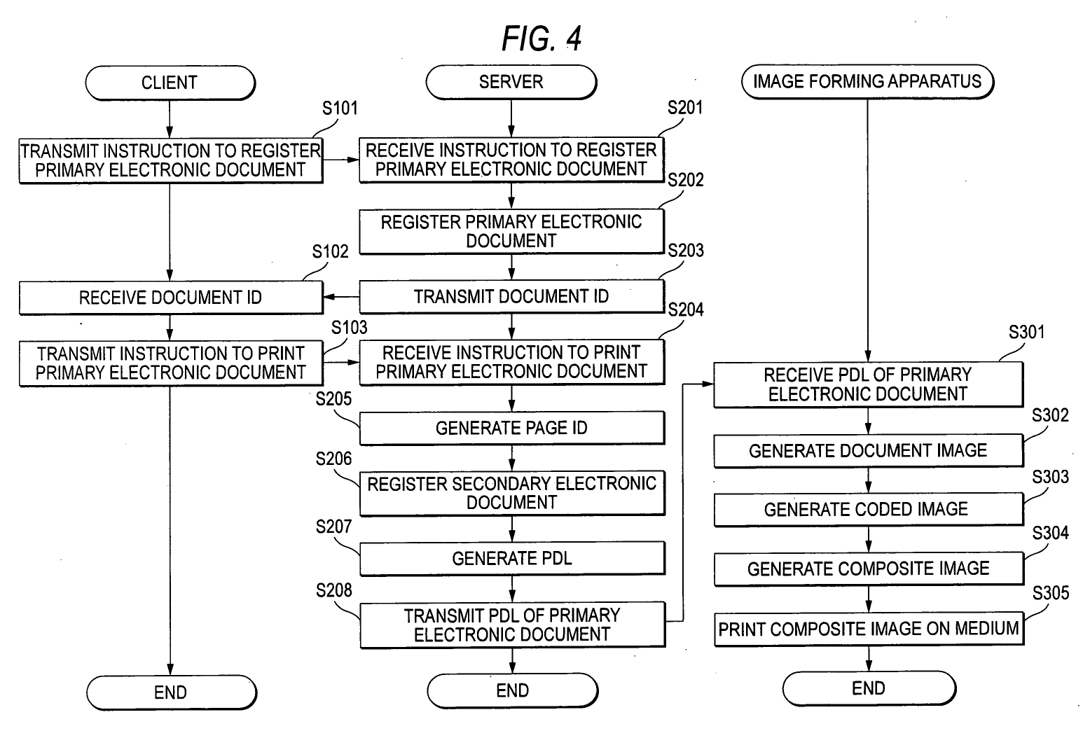

FIG. 4 is a flowchart which shows the operation of the system performed then.

Firstly, the user prepares a primary electronic document on the client 10. Then, the user operates the client 10 to enter the primary electronic document for registration. Here, as the primary electronic document, a text file containing only characters, a document file prepared using document preparation software, and a file (PDF or the like) in which the document file is converted into a print form are raised.

When so operated, the client 10 transmits an instruction to the server 20 to register the primary electronic document (step 101).

This triggers the server 20 to perform a process to register the primary electronic document.

Namely, firstly, the reception unit 21 receives the instruction to register the primary electronic document and passes the primary electronic document which has been sent thereto together with the registration instruction to the primary document management unit 22 (step 201).

Then, the primary document management unit 22 registers the primary electronic document (step 202).

To be specific, the following process will be implemented.

Firstly, the primary document management unit 22 stores the primary electronic document in the primary document storage unit 23. Note that as this occurs, the primary document management unit 22 obtains information (for example, URL) on a storage location for the primary electronic document in the primary document storage unit 23.

Next, the primary document management unit 22 generates document ID. Note that the document ID is, for example, an UUID (Universally Unique Identifier) that is generated in a document management server. Here, the UUID means an ID in which an MAC address that each apparatus possesses is combined with a time when a document ID is generated. Then, the primary document management unit 22 stores the information on the storage location obtained when storing the primary electronic document and the document ID generated in the management storage unit 27 in such a manner that the storage location information is made equivalent to the document ID. In addition, as this occurs, the primary document management unit 22 also stores a name of the primary electronic document and information on history of operation of the primary electronic document in a related fashion.

When the registration process of the primary electronic document is completed in this way, the primary document management unit 22 transmits the document ID to the transmission unit 29.

On the other hand, the client 10 receives the document ID (step 203).

Then, the user operates the client 10 to issue an instruction to print the primary electronic document.

When so operated, the client 10 transmits an instruction to the server 20 to print the primary electronic document (step 103). Note that the print instruction includes the document ID which was received in step 102 as information which specifies the primary electronic document which is instructed to be printed. In addition, the print instruction also includes setting information on printing (hereinafter, referred to simple as “setting information”). Here, although the setting information includes size and orientation of a sheet and the like, in this exemplary embodiment, in particular, information on access authorization to the secondary electronic document is to be included therein. This access authorization information may be such as to be inputted by the user or downloaded from other services.

Through the operations described above, the server 20 performs a print instruction process of the primary electronic document.

Namely, firstly, the reception unit 21 receives a print instruction of the primary electronic document (step 204). Then, the reception unit 21 passes the document ID contained in the print instruction to the primary document management unit 22, the page ID management unit 26 and the secondary document management unit 24.

Then, the page ID management unit 26 generates a page ID (step 205).

To be specific, the following process will be implemented.

Firstly, by referring to the management information storage unit 27, the page ID management unit 26 obtains a current value M for a page ID which corresponds to the document ID passed thereto from the reception unit 21. Here, the current value M of the page ID means a maximum value of a page ID which was generated when the same document was printed previously, and the maximum value stored in a memory, not shown, is read out. In addition, the number N of page IDs which are necessary for printing this time is obtained. Then, an “M+N” is generated from the page IDs “M+1.” Note that in this case, the number of page IDs to be generated is determined in accordance with setting information. Namely, basically, a number of page IDs are generated which are equivalent to a number obtained by multiplying the number of pages to be printed by the number of copies to be printed. However, in the event that there exists an N-up designation in the setting information, the N-up designation also has to be taken into consideration. For example, in the event that 10 pages of an electronic document are printed five copies with a 2-up designation, 25 page IDs (=10÷2×5) are generated. Then, finally, the maximum value “M+N” of the page IDs generated this time is stored in the memory, not shown, so that it can be referred to next time page IDs are generated.

In the exemplary embodiment, the identification information of the medium is generated by combining the document ID and the page IDs in this way, and the page ID is counted up every time the same electronic document is printed.

Thereafter, the page ID management unit 26 registers the page IDs in the management information storage unit 27. Specifically speaking, the page IDs generated here are so stored while being related to the document ID passed from the reception unit 21.

Next, a process is implemented for registering the secondary electronic document which reflects a print image of the primary electronic document, which is an object to be printed (step 206).

Specifically speaking, the following process will be implemented.

Firstly, the primary document management unit 22 retrieves the management information storage unit 27 using the document ID passed thereto as a key, so as to obtain information on the storage location of the primary electronic document. Then, the primary document management unit 22 obtains the primary electronic document from the storage location, so as to pass the same document to the secondary electronic document management unit 24.

Next, the secondary document management unit 24 generates a secondary electronic document which reflects a print image of the primary electronic document passed thereto from the primary document management unit 22 and stores it in the secondary document storage unit 25.

Here, the secondary electronic document can be generated as a format which limits change in print image of the primary electronic document. As the format of the secondary electronic document like this, the “XDW format” in the “DocuWorks” by Fuji Xerox Inc. and the “PDF format” in the “Acrobat” by Adobe Systems Inc. in the United States of America are raised.

In addition, when storing the secondary electronic document, the secondary document management unit 24 obtains information (for example, URL) on the storage location of the primary electronic document in the secondary document storage unit 25. Then, the information on the storage location in the secondary document storage unit 25 is stored in the management information storage unit 27. As this occurs, however, the secondary document management unit 24 relates the information on the storage location of the secondary electronic document to those of the page IDs corresponding to the document ID passed from the reception unit 21 which have not yet been related to the secondary electronic document sequentially in the order of their increasing page ID values or from those with smaller ID values. Furthermore, as this occurs, the secondary electronic document is stored while being related to information on access authorization which is contained in the setting information.

Thereafter, the PDL generation unit 28 generates a document PDL which is made up of a command string or printing the primary electronic document. In addition, the PDL generation unit 28 receives the document ID from the secondary document management unit 24 and fetches page IDs which have been generated this time from the management information storage unit 27. Then, the PDL generation unit 28 generates a PDL which is to be outputted to the image forming apparatus 30 by setting the document ID and the page IDs in a document PDL (step 207). The PDL generation unit 28 then passes this PDL to the transmission unit 29.

Then, the transmission unit 29 transmits the PDL passed thereto to the image forming apparatus 30 as a PDL for the primary electronic document (step 208).

The image forming apparatus 30 then receives the PDL for the primary electronic documents in this way (step 301). The image forming apparatus 30 generates a document image of the primary electronic document (step 302). In addition, the image forming apparatus 30 codes the document ID and the page IDs set in the PDL, so as to generate an identification code for a medium. In addition, the image forming apparatus 30 codes coordinates information which is prepared in accordance with the setting information, so as to generate a position code. Then, the image forming apparatus 30 images the identification code and the position code, so as to generate a coded image (step 303).

Next, the image forming apparatus 30 combines the document image with the coded image, so as to generate a composite image. Then, by printing the composite image on a medium using, for example, an electronic photography method, a print document 40 is outputted (step 305).

In addition, as this occurs, the document image is formed using toners such as C (cyan), M (magenta) and Y (yellow), and the coded image is formed using a special toner.

Here, as the special toner, an invisible toner is raised as an example which has a maximum absorption index of 7% or less in a visible light range (400 nm to 700 nm) and an absorption index of 30% or more in a near-infrared radiation range (800 nm to 1000 nm). Here, “visible” and “invisible” has nothing to do with whether or not the toner is visually recognized. Discrimination between visible and invisible toners is made based on whether or not an image formed on a printed medium can be recognized through the existence of color development attributed to absorption of a specific wavelength within the visible light range. In addition, in the event that an image formed has slight color development which is attributed to absorption of a specific wavelength within the visible light range but is difficult to be recognized by the eyes of a human being, the image is treated as “invisible.”

In addition, in order to enhance the absorbing capability of near-infrared radiation, the invisible toner desirably has an average dispersion diameter which falls within a range of 100 nm to 600 nm.

Here, management information that is generated in this exemplary embodiment will be described specifically.

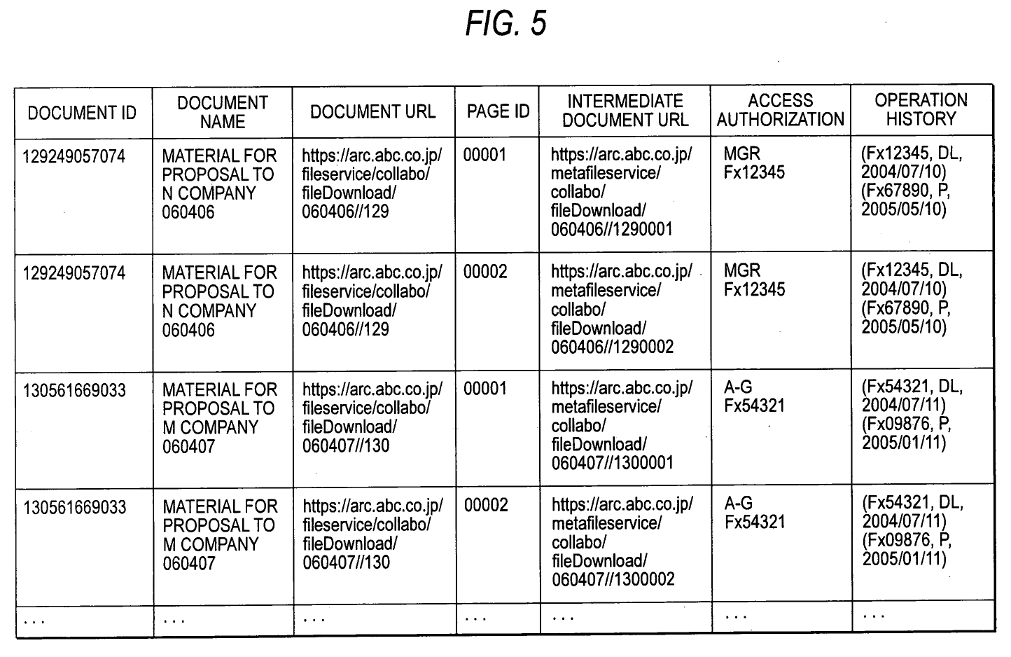

FIG. 5 is a chart which shows specifically the contents of management information in this exemplary embodiment.

As is shown in the figure, in management information, a document ID, a document name, a document URL, a page ID, and an intermediate document URL are related to each other. In addition, as an example of information which controls the usage of the secondary electronic document, an access authorization is related thereto, and as an example of information on operations that have been made on the secondary electronic document, a operation history is related thereto.

Firstly, as has been described previously, the document ID is the identification information which uniquely identifies the primary electronic document which constitutes an object to be printed. In addition, the document name is a name given to the primary electronic document by the user. Furthermore, the document URL is the information which indicates the storage location of the primary electronic document in the primary document storage unit 23. Note that in the chart, information in first and second lines is for an identical primary electronic document, and information in third and fourth lines is for another identical primary electronic document. Therefore, the document ID, document name and document URL are the same in the first and second lines, and the same thing occurs in the third and fourth lines.

In addition, as has been described previously, the page ID is the identification information which identifies a page in the print document 40. Here, in this exemplary embodiment, numbers such as “0001,” “0002,” “0003,” . . . are adopted for the page ID for each of the primary electronic documents. Consequently, it is considered that the same page IDs appear for the different primary electronic documents. However, since no completely identical page IDs appear in consideration of combinations of the document IDs and the page IDs, it is designed that media can uniquely be identified by such combinations.

Furthermore, the intermediate document URL is the information which indicates a storage location of an intermediate document (a secondary electronic document) that is generated based on the print image of the primary electronic document which is reflected thereby.

Moreover, as the access authorization, information of those who are authorized to access intermediate documents (secondary electronic documents) is set based on their titles, names of groups to which they belong, employee numbers and the like. For example, in the first line, “MGR,” and “Fx12345” are set as the access authorization. This means that only managers or an employee whose employee number is “Fx12345” can access an intermediate document which is managed in the first line. The same thing applied to the second line. In addition, “A-G,” and “Fx54321” are set in the third line as the access authorization. This means that only those who belong to a group “A” or an employee whose employee number is “Fx54321” can access to an intermediate document which is managed in the third line. The same thing applies to the fourth line.

Additionally, as the operation history, histories of operations made on the intermediate documents (the secondary electronic documents) are recorded. For example, as the operation history, “(Fx12345, DL, 2004/07/10)” and “(Fx67890, P, 2005/05/10)” are recorded in the first line. This means that the intermediate document managed in the first line was downloaded on Jul. 10, 2004 by an employee whose employee number was “Fx12345” and was printed on May 10, 2005 by an employee whose employee number was “Fx67890.” The same thing applies to the second line. In addition, as the operation history, “(Fx54321, DL, 2004/07/11)” and “(Fx09876, P, 2005/01/11)” are recorded in the first line. This means that the intermediate document managed in the third line was downloaded on Jul. 11, 2004 by an employee whose employee number was “Fx54321” and was printed on Jan. 11, 2005 by an employee whose employee number was “Fx09876.” The same thing applies to the second line.

A code pattern based on which a coded image is generated in this exemplary embodiment will be described here.

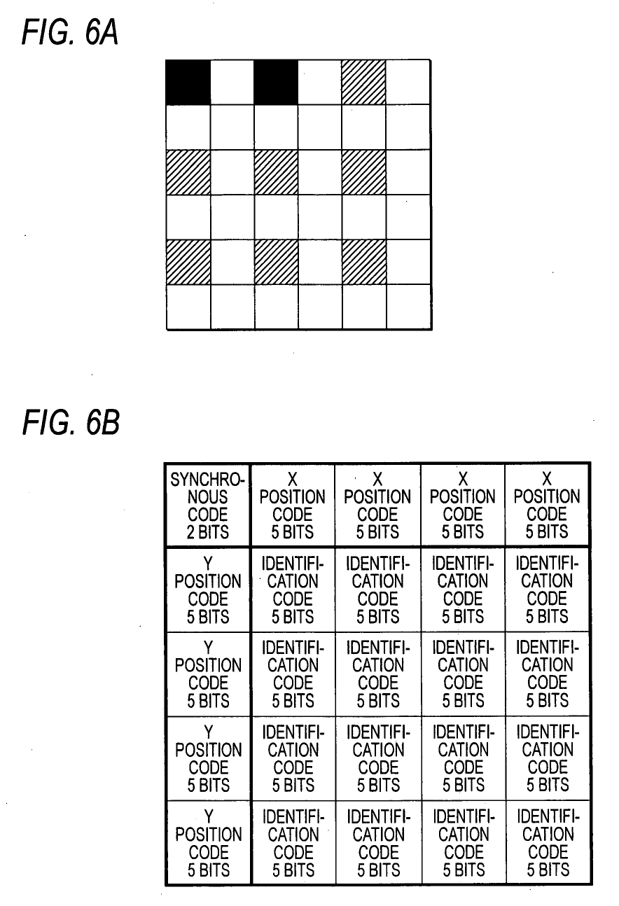

FIGS. 6A and 6B show diagrams which explain a code pattern.

Firstly, a bit pattern which makes up a code pattern will be described.

An example of bit pattern or arrangement of bits is shown in FIG. 6A.

The bit pattern is a minimum unit in embedding information. Here, as is shown in FIG. 6A, bits are arranged in two locations selected from nine locations. In the figure, black squares indicate locations where a bit is arranged, squares shaded with diagonal lines indicate locations where no bit is arranged. There are 36 (=₉C₂) combinations which select two locations out of nine locations. Consequently, by the bit arranging method like this, information can be represented in 36 different ways (about 5.2 bits).

Incidentally, a minimum square shown in FIG. 6A has a size of 2 dots×2 dots in 600 dpi. Since the size of one dot in 600 dpi is 0.0423 mm, a side of the minimum square is 84.6 μm (=0.423 mm×2). Since a dot which makes up a code pattern becomes conspicuous as it grows in size, the dot is preferably as small as possible. In the event that it becomes too small, however, the dot cannot be printed by a printer. Then, as the size of the dot, the aforesaid value, which is larger than 50 μm but smaller than 100 μm, is adopted. Namely, the size of 84.6 μm×84.6 μm is a minimum size that can be printed stably by a printer.

Note that by sizing the dot in such a way, one side of a single bit pattern becomes about 0.5 mm (=0.423 mm×2×6).

In addition, a code pattern made up of bits pattern like this will be described.

FIG. 6B shows an example of code pattern or arrangement of bit patterns.

Here, a minimum square shown in FIG. 6B corresponds to the bit pattern shown in FIG. 6A. Note that while in FIG. 6A, a single bit pattern is described as being able to represent information in 36 different ways, in this code pattern, too, a single bit pattern is understood to be able to represent information in 32 different ways (5 bits) except for a synchronous code.

An identification code in which identification information is coded is embedded using 16 (=4×4) bit patterns. In addition, an X position code in which position information in an X direction is coded and a Y position code in which position information in a Y direction is coded are embedded using four bit patterns, respectively. Furthermore, a synchronous code for detecting a position of a code pattern and rotation thereof is embedded in a top left-hand side corner using one bit pattern.

Note that since the size of a single code pattern equals a total width of five bit patterns, it becomes about 2.5 mm. In this exemplary embodiment, a coded image in which a code pattern generated in that way is imaged is arranged on the whole surface of a sheet.

Next, a process will be described in which identification information and position information are coded and a coded image is generated from the pieces of coded information. Note that this process is executed in step 303 in FIG. 4.

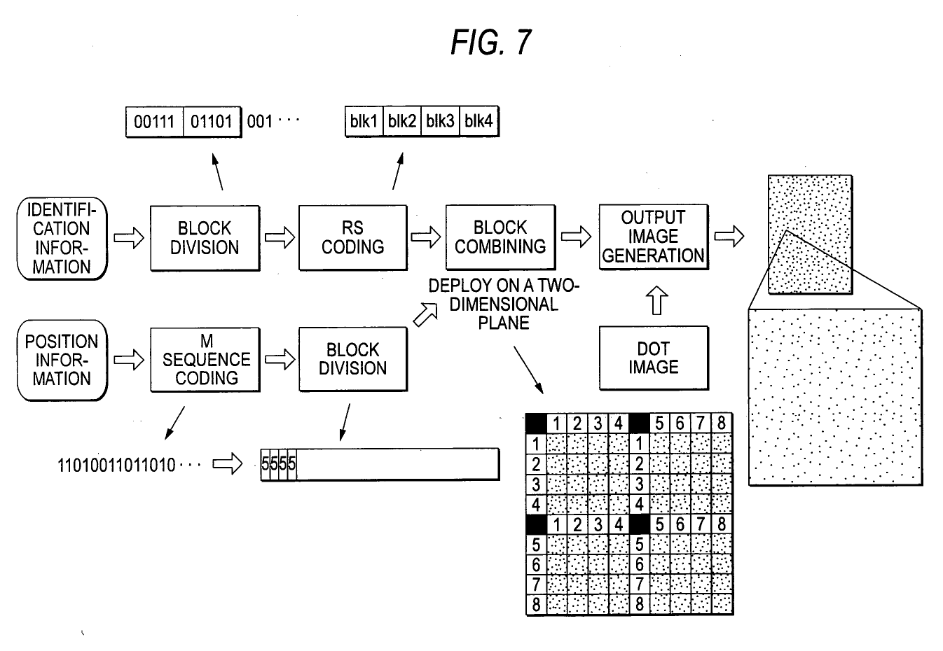

FIG. 7 is a diagram which explains such a coding and imaging process.

Firstly, the coding of identification information will be described.

The RS (Reed-Solomon) code based on the block coding method is used in coding identification information. As has been described in FIGS. 6A and 6B, in this exemplary embodiment, information is embedded using a bit pattern which can represent information of five bits. Consequently, since erroneous information is generated by five bits, the RS codes are used which is based on the block coding method and which has a good coding efficiency. However, the coding method is not limited to the RS code, and hence other coding methods, for example, the BCH code can also be used.

As has been described above, in this exemplary embodiment, information is embedded using a bit pattern having an information volume of five bits. Consequently, the block length of the RS code needs to be five bits. Because of this, identification information is divided by five bits for blocking. In FIG. 7, a first block “00111” and a second block “01101” are detached from identification information “0011101101001 . . . ”

Then, an RS coding process is implemented on the blocked identification information. In FIG. 7, after the identification information is blocked into “blk1,” “blk2,” “blk3,” “blk4,” the RS coding is implemented.

Incidentally, in this exemplary embodiment, the identification information is divided into 16 (=4×4) blocks. Then, the number of code blocks in the RS code can be 16. In addition, the number of information blocks can be designed depending on a condition where errors are generated. In the event that the number of information blocks is, for example, 8, an RS (16, 8) code results. This code has a nature that even though four erroneous blocks (=(16−8)÷2) are generated in coded information, the blocks can be corrected. Note that in this case, the volume of information stored in the information blocks is 40 bits (=5 bits×8 bits). Consequently, about a trillion types of identification information can be represented.

Next, the coding of position information will be described.

The M sequence code, which is one form of the pseudo-random number sequence, is used in coding position information. Here, the M sequence is a sequence of a maximum period which can generate a K-step linear shift register and has a sequence length of 2^{K}−1. Arbitrary continuous K bits which are fetched from the M sequence have a nature that they never appear in other positions in the same M sequence. Then, by making use of this nature, position information is coded.

Incidentally, in this exemplary embodiment, the degree of a necessary H sequence is obtained from the length of position information to be coded, so as to generate an M sequence. However, in a case where the length of position information to be coded is known in advance, an M sequence does not have to be generated every time. Namely, a fixed M sequence is generated in advance, so as to be stored in a memory or the like.

For example, assume that an M sequence (K=13) having a sequence length of 8191 is used.

In this case, since position information is also embedded by five bits, blocking is implemented by taking out five bits at a time from the M sequence having the sequence length of 8191. In FIG. 7, the M sequence “11010011011010 . . . ” is divided into a block of five bits at a time.

In this exemplary embodiment, the different coding methods are used for position information and identification information in this way. This is because the detection capability of identification information needs to be set in such a manner as to become higher than the detection capability of position information. Namely, since the position information is information which is only for obtaining a position of a sheet surface, even though there exists therein a portion which cannot be decoded due to noise or the like, only the relevant portion is lost and the other portions are not affected thereby. In contrast to this, in the event that the identification information fails to be decoded, an object which reflects written information cannot be detected.

As has been described heretofore, when after the identification information has been divided, coding is implemented by the RS code, and after having been coded by the M sequence, the position information is divided into blocks, as is shown in the figure, the blocks are combined. Namely, the blocks are deployed on a two-dimensional plane in a format shown. The format shown in FIG. 7 corresponds to the format shown in FIG. 6B. Namely, black squares denote synchronous codes. In addition, “1,” “2,” “3,” “4,” . . . which are arranged in a horizontal direction mean X position codes, and “1,” “2,” “3,” “4,” . . . which are arranged in a vertical direction mean Y position codes. Since differently positioned media have different information, the position codes are indicated by numeric characters which correspond to coordinate positions. On the other hand, grey squares denote identification codes. Since the same information is disposed even on differently positioned media, the identification codes are all indicated by the same marks.

Incidentally, as is seen from the figure, there are four bit patterns interposed between two synchronous codes. Consequently, a partial sequence of 20 (=5×4) bits of the M sequence can be disposed. In the even that a partial sequence of 13 bits is fetched from the partial sequence of 20 bits, it becomes possible to specify a location of the partial sequence of 13 bits in the total sequence (8191). In the event that 13 bits out of 20 bits are used to specify a location in this way, the detection or correction of an error in the 13 bits so fetched can be implemented using the remaining seven bits. Namely, it becomes possible to enable the detection and correction of such an error by verifying the consistency of the 20 bits using the same generating polynomial as that used when the M sequence was generated.

Thereafter, the bit pattern in each bock is imaged by referring to dot images. Then, an output image is generated which is represented by dot information shown rightmost in FIG. 7.

Next, an operation will be described which is made on a medium when writing is performed thereon.

Note that in this exemplary embodiment, writing is performed on a print document 40 using an electronic pen 60 which can read a coded image on the print document 40.

Then, firstly, the electronic pen 60 will be described.

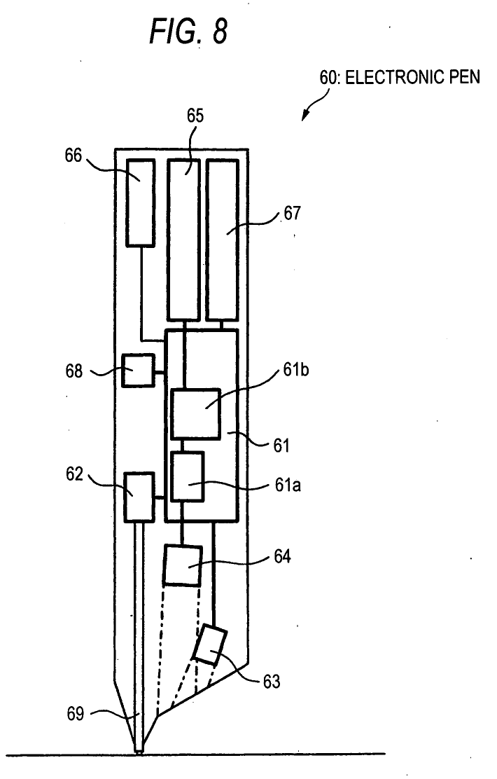

FIG. 8 is a diagram which shows the mechanism of the electronic pen 60.

As is shown in the figure, the electronic pen 60 includes a control circuit 61 for controlling the movement of the whole pen. In addition, the control circuit 61 includes an image processing unit 61a for processing a coded image detected from an input image and a data processing unit 61b for extracting identification information and position information from the result of the processing.

In addition, a pressure sensor 62 is connected to the control circuit 61 for detecting a writing operation by the electronic pen 60 through a pressure applied to a pen tip 69. Additionally, an infrared LED 63 for shining infrared light on to a medium and an infrared CMOS 64 for inputting an image are also connected to the control circuit 61. Furthermore, an information memory 65 for storing identification information and position information, a communication circuit 66 for communicating with an exterior device, a battery 67 for driving the pen and a Pen ID memory 68 for storing identification information of the pen (a pen ID) are also connected to the control circuit 61.

Here, the operation of the electronic pen 60 will briefly be described.

When writing by the electronic pen 60 is performed, the pressure sensor 62, which is connected to the pen tip 69, detects a writing operation, whereby the infrared LED 63 is lit, and the infrared CMOS 64 photographs an image on the medium by a CMOS sensor.

Note that the infrared LED 63 is pulse lit in synchronism with a shutter timing of the CMOS sensor in order to suppress the consumption of electric power.

In addition, the infrared CMOS 64 utilizes a CMOS sensor of a global shutter method which can transfer a photographed image as soon as photographing is implemented. In addition, a CMOS sensor is used which has sensitivity in the infrared range. Additionally, in order to decrease the influence by disturbance, a visible light cut-off filter is disposed over the whole surface of the CMOS sensor. The CMOS sensor photographs images over a cycle of the order of 70 fps to 100 fps (frame per second). Note that the photographing device is not limited to the CMOS sensor, and hence, other photographing devices such as a CCD may be used.

When an image photographed in this way enters the control circuit 61, the control circuit 61 obtains a coded image from the photographed image. Then, the control circuit 61 decodes the coded image so obtained, so as to obtain identification information and position information which are embedded in the coded image.

Hereinafter, the operation of the control circuit 61 as this occurs will be described.

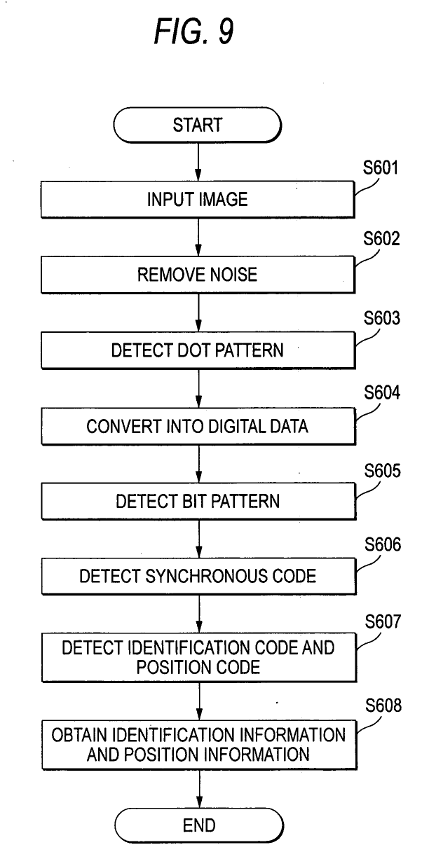

FIG. 9 is a flowchart which illustrates the operation of the control circuit 61.

Firstly, the image processing unit 61a inputs an image (step 601). Then, the image processing unit 61a performs a process for removing noise contained in the image (step 602). Here, as noise, noise generated by variation in CMOS sensitivity and electronic circuits or the like is raised. A type of process to be performed to remove noise should be determined in accordance with the characteristics of the photographing system of the electronic pen 60. For example, a gray processing or a sharpening processing such as an unsharp masking can be applied.

Next, the image processing unit 61a detects a dot pattern (a position of a dot image) from the image. For example, a dot pattern portion and a background portion are separated by a binarization processing, so as to detect a dot pattern from individual binarized positions. In the event that many noise components are contained in the binarized images, a filtering process needs to be combined for determining on a dot pattern by areas and shapes of the binarized images.

In addition, the image processing unit 61a converts the dot pattern so detected into digital data on a two-dimensional array (step 604). For example, on the two-dimensional array, a position where there exists a dot is converted into “1” whereas a position where there exists no dot is converted into “0.” Then, the digital data on the two-dimensional array is passed from the image processing unit 61a to the data processing unit 61b.

Following this, the data processing unit 61b detects a bit pattern made up of a combination of the two bits shown in FIG. 6A (step 605). For example, a bit pattern can be detected by moving a boundary position defining a block which corresponds to a bit pattern on the two-dimensional array and detecting a boundary position which enables the number of dots contained in a block to be two.

When a bit pattern is detected in this way, the data processing unit 61b detects a synchronous code by referring to the type of the bit pattern so detected (step 606). In addition, the data processing unit 61b detects identification code and position code based on a positional relationship from the synchronous code so detected (step 607).

Thereafter, the data processing unit 61b decodes the identification code to obtain identification information and decodes the position code to obtain position information (step 608). RS decoding is implemented on the identification code to obtain the identification information. On the other hand, by comparing the position of the partial sequence read out with the M sequence used when generating the image with respect to the position code, the position information is obtained.

Thereafter, the electronic pen 60 adds written data to the secondary electronic document by transmitting the identification information so obtained such as identification information for the medium which is made up of a combination of the document ID and the page ID and the position information so obtained such as coordinates information to the server 20.

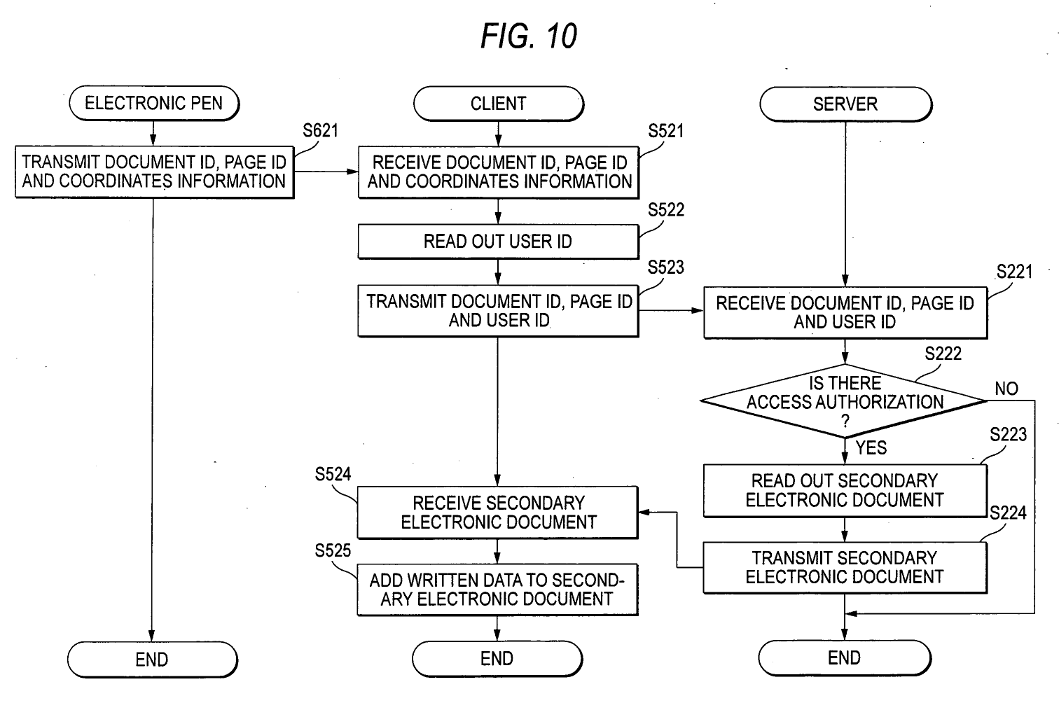

FIG. 10 is a flowchart which illustrates the operation of the system as this occurs.

Firstly, the electronic pen 60 transmits the document Id, the page ID and the coordinates information to the client 50 (step 621).

By this transmission, the client 50 receives the document ID, the page ID and the coordinates information (step 521). Then, the client 50 reads out identification information for the user who is working thereon (hereinafter, referred to as a “user ID”) from its memory (step 522) and transmits the user ID so read out together with the document ID and the page ID to the server 20 (step 523). Note that the user ID is such as to be inputted into the client 50 when he or she starts working thereon so as to be stored in the memory within the client 50.

By this transmission, in the server 20, firstly, the reception unit 21 receives the document Id, the page ID and the user ID and passes them to the secondary document management unit 23 (step 221).

Then, the secondary document management unit 24 refers to the access authorization corresponding to the combination of the document ID and the page ID in the management information storage unit 27. Then, the secondary document management unit 24 determines whether or not the user ID, which was passed thereto together with the document ID and the page ID, has the access authorization (step 222). Note that the determination here is implemented, in the event that user IDs (for example, employee numbers) of users who can access secondary electronic documents are described as the access authorization, by comparing the user ID passed thereto from the reception unit 21 directly with the user IDs in the access authorization. In addition, in the event that titles and names of groups to which users belong who are allowed to access secondary electronic documents are described as the access authorization, the determination is made through the following process. Namely, firstly, a title and a name of the group to which the user belongs whose user ID was passed from the reception unit 21 are obtained based on a data base prepared separately. Then, the title and the name of the group of the user so obtained are compared with the titles and the names of groups in the access authorization.

Here, if the user ID passed from the reception unit 21 has the access authorization, the secondary document management unit 24 refers to the management information storage unit 27 so as to obtain information on the memory location of the secondary electronic document. Then, using the information so obtained, the secondary document management unit 24 reads out the secondary electronic document from the secondary document storage unit 25 and passes it to the transmission unit 29 (step 223).

On the other hand, if the user ID passed from the reception unit 21 has no access authorization, although not shown, the transmission unit 29 transmits, for example, an error message to the client 50 and ends the process.

Then, the transmission unit 29 transmits the secondary electronic document to the client 50 (step 224).

By this transmission, the client 50 receives the secondary electronic document (step 524).

Then, the client 50 adds written data to the secondary electronic document so received based on the coordinates information received in step 521 (step 525).

Thus, the operation of this exemplary embodiment ends.

Note that while in this exemplary embodiment, the page IDs are generated in the server 20, a configuration may be adopted in which page IDs are generated in the client 10, so as to be transmitted to the server 20.

In addition, while in the aforesaid exemplary embodiment, the combination of the document ID and the page ID is assumed as the medium identification information, the invention is not limited thereto.

Namely, by combining information which specifies the sever 20 and information which specifies individually the print instructions of the print instructions by the server 20, medium identification information may be made to be generated. Alternatively, in the event that the medium identification information is generated in the client 10, by combining information which specifies the client 10 and information which specifies individually the print instructions of the print instructions by the client 10, medium identification information may be made to be generated. Here, as the information which specifies the individual print instructions, for example, the order of print instructions or times of print instructions can be considered.

In addition, the identification information of the medium may not have to be continuous values or significant value, and hence, a value generated as a random number or a value generated as a separate UUID may be used as the medium identification information. Namely, the medium identification information may be a so-called sheet ID which enables the trace of a page which corresponds to the secondary electronic document without knowing the document ID thereof.

Furthermore, the exemplary embodiment has been described on the premise of transmitting the secondary electronic document to the client 50 for direct addition of written data thereto.

However, it may be configured such that the information on the memory location of the secondary electronic document is transmitted to the client 50 in place of transmitting first the secondary electronic document itself to the client 50. In this case, the client 50 is made to obtain the secondary electronic document based on the information on the memory location thereof. Alternatively, it may be configured such that the setting information for generating a secondary electronic document is transmitted to the client 50. In this case, the client 50 is made to generate a secondary electronic document based on the setting information.

In addition, it may be configured such that the written data is not added directly to the secondary electronic document but is related to the information which specifies the secondary electronic document on the data base. Alternatively, it may be configured such that the written data is held together with the information which specifies the secondary electronic document as a file. Namely, any method can be applied, provided that the method is such that the written data and the secondary electronic document are related to each other in advance, so that the secondary electronic document and the written data can be represented in a superposed fashion as required.

### Second Exemplary Embodiment

In this exemplary embodiment, as has been described previously, the image forming apparatus 30 and the sever 20 play a main role in performing the processing.

Then, firstly, the functions and configurations of the image forming apparatus 30 and the server 20 in this exemplary embodiment will be described.

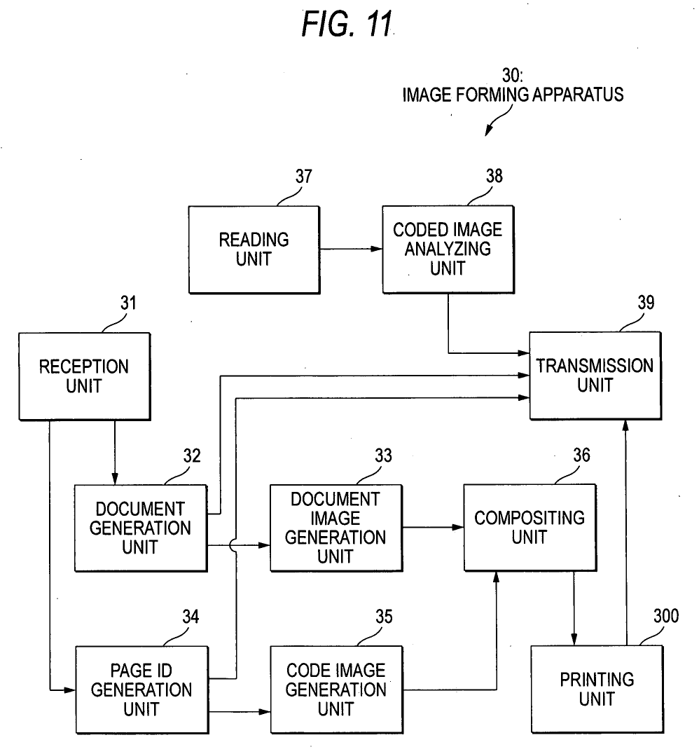

FIG. 11 is a diagram showing the function and configuration of the image forming apparatus 30.

As is shown in the figure, the image forming apparatus 30 includes a reception unit 31, a document generation unit 32, a document image generation unit 33, a page ID generation unit 34, a coded image generation unit 35, a compositing unit 36, a reading unit 37, a coded image analyzing unit 38, a transmission unit 39 and a printing unit 300.

The reception unit 31 receives a PDL of a primary electronic document from the client 10.

The document generation unit 32 generates a secondary electronic document which reflects a print image of the primary electronic document based on the PDL of the primary electronic document.

The document image generation unit 33 generates a document image of the primary electronic document based on the secondary electronic document.

The page ID generation unit 34 generates a page ID which identifies a page of the print document 40. Note that in this exemplary embodiment, the page ID generation unit 34 is adopted as an example of a generation unit that generates identification information which specifies a medium.

The coded image generation unit 35 generates a coded image in which a document ID, a page ID, coordinates information are coded and imaged.

The compositing unit 36 generates a composite image in which the coded image is superposed on the document image of the primary electronic document.

The coded image analyzing unit 38 analyzes the coded image which results from scanning the print document 40 and obtains a document ID and a page ID.

The transmission unit 39 transmits the document ID, the page ID, the secondary electronic document and the like to the server 20 in response to the reception of the PDL of the primary electronic document. In addition, the transmission unit 39 transmits the document ID and the page ID to the client 50 in response to scanning the print document 40.

Note that these functions are realized through cooperation between software and hardware resources. To be specific, a CPU of the image forming apparatus 30 reads out a program which realizes the reception unit 31, the document generation unit 32, the document image generation unit 33, the page ID generation unit 34, the coded image generation unit 35, the compositing unit 36, the coded image analyzing unit 38, and the transmission unit 39 from, for example, a magnetic disk unit into a main memory and executes the program. In addition, programs and data that are to be stored in the magnetic disk unit may be loaded from a recording medium such as a CD or downloaded via a network such as the internet.

On the other hand, the reading unit 37 reads an image from the print document 40. As this reading unit 37, a scanner can be used which illuminates a medium and reads reflected light or the like to convert it into digital data. In this case, a configuration can be adopted in which light is shone on to a surface of a medium from, for example, an LED (Light Emitting Diode) light source, reflected light of the light shone on to the medium surface is optically reduced by an imaging lens, and an optical image formed is photoelectrically converted by an image sensor.

Incidentally, in this exemplary embodiment, the document image in which the primary electronic document is imaged, the document ID and the coded image in which the page ID is coded and imaged are formed on a medium. In this case, while the document image is formed by a visible toner, the coded image is formed by an invisible toner having an absorption wavelength in, for example, an infrared range. Consequently, as the LED light source, in addition to, for example, a while LED which emits visible light, an infrared LED is provided which emits infrared light. In addition, as the image sensor, in addition to a sensor for red light, a sensor for green light and a sensor for blue light, a sensor for infrared light is provided.

In addition, the printing unit 300 is a mechanism for printing a composite image generated by the compositing unit. For example, although an electronic photography method can be used to implement printing, any other methods may be used to implement printing.

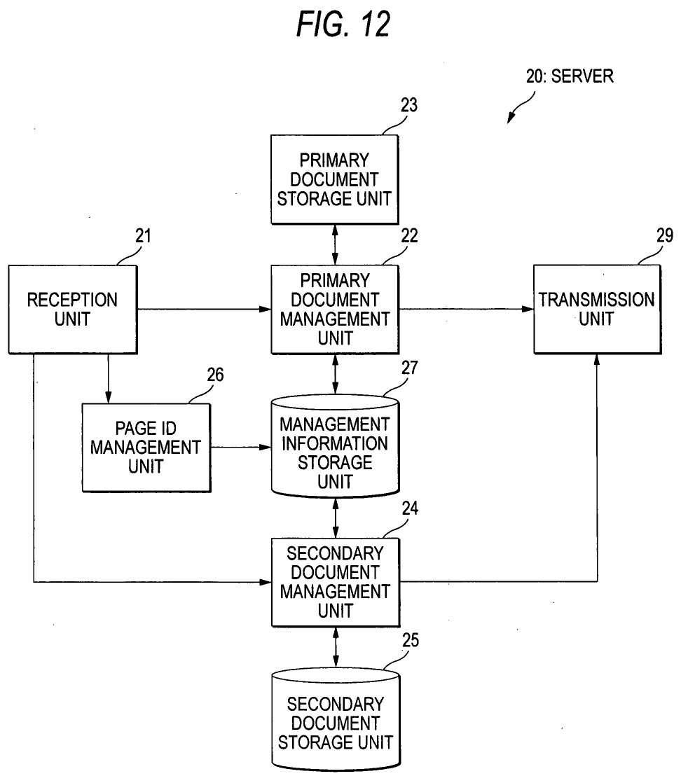

On the other hand, FIG. 12 is a diagram showing the function and configuration of the server 20.

As is shown in the figure, the server 20 includes a reception unit 21, a primary document management unit 22, a primary document storage unit 23, a secondary document management unit 24, a secondary document storage unit 25, a page ID management unit 26, a management information storage unit 27, and a transmission unit 29.

The reception unit 21 receives from the client 10 an instruction to enter a primary electronic document for registration, receives from the image forming apparatus 30 an instruction to enter a secondary electronic document for registration, and receives from the client 50 an instruction to transmit the secondary electronic document.

The primary document management unit 22 stores the primary electronic document in the primary document storage unit 23 in response to the instruction to register the primary electronic document and stores information such as a document ID or the like which identifies the primary electronic document in the management information storage unit 27.

The primary document storage unit 23 corresponds to the primary document storage area in FIG. 2 and stores therein the primary electronic document.

The secondary document management unit 24 stores the secondary electronic document in the secondary document storage unit 25 in response to the instruction to register the secondary electronic document and stores information on such as a storage location of the secondary electronic document in the management information storage unit 27. In addition, the secondary document management unit 24 reads out the secondary electronic document from the secondary document storage unit 25 in response to the instruction to transmit the secondary electronic document. Note that in this exemplary embodiment, as an example of a processing unit that performs a process which enables the utilization of the secondary electronic document, the secondary document management unit 24 is adopted.

The secondary document storage unit 25 corresponds to the secondary document storage area in FIG. 2 and stores therein the secondary electronic document.

The page ID management unit 26 stores a page ID received in the management information storage unit 27 in response to the instruction to register the secondary electronic document.

The management information storage unit 27 corresponds to the management information storage area in FIG. 2 and stores therein management information in which the document ID, the page ID, a storage location of the primary electronic document, the storage location of the secondary electronic document and the like are made equivalent to each other. Note that in this exemplary embodiment, as an example of print information in which the identification information which identifies the medium, the secondary electronic document and the like are related to each other, this management information is adopted.

The transmission unit 29 transmits the document ID back to the client 10 in response to the instruction to register the primary electronic document from the client 10. In addition, the transmission unit 29 transmits the secondary electronic document back to the client 50 in response to the instruction to transmit the secondary electronic document from the client 50.

In addition, in the exemplary embodiment, as an example of the generation unit that generates print information, a combination of the primary document management unit 22, the secondary document management unit 24 and the page ID management unit 26 is adopted.

Note that these functions are realized through cooperation between software and hardware resources. To be specific, a CPU of the server 20 reads out a program which realizes the reception unit 21, the primary document management unit 22, the secondary document management unit 24, the page ID management unit 26, and the transmission unit 29 from, for example, a magnetic disk unit into a main memory and executes the program. In addition, the primary document storage unit 23, the secondary document storage unit 25 and the management information storage unit 27 can be realized using, for example, a magnetic disk unit. Furthermore, programs and data that are to be stored in the magnetic disk unit may be loaded from a recording medium such as a CD or downloaded via a network such as the internet.

Next, the operation of the system in this exemplary embodiment will be described.

Incidentally, the operation of the system in this exemplary embodiment is made up of an operation performed in implementing printing on to a medium and an operation performed in scanning a medium.

Then, firstly, the operation performed in implementing printing on to a medium will be described.

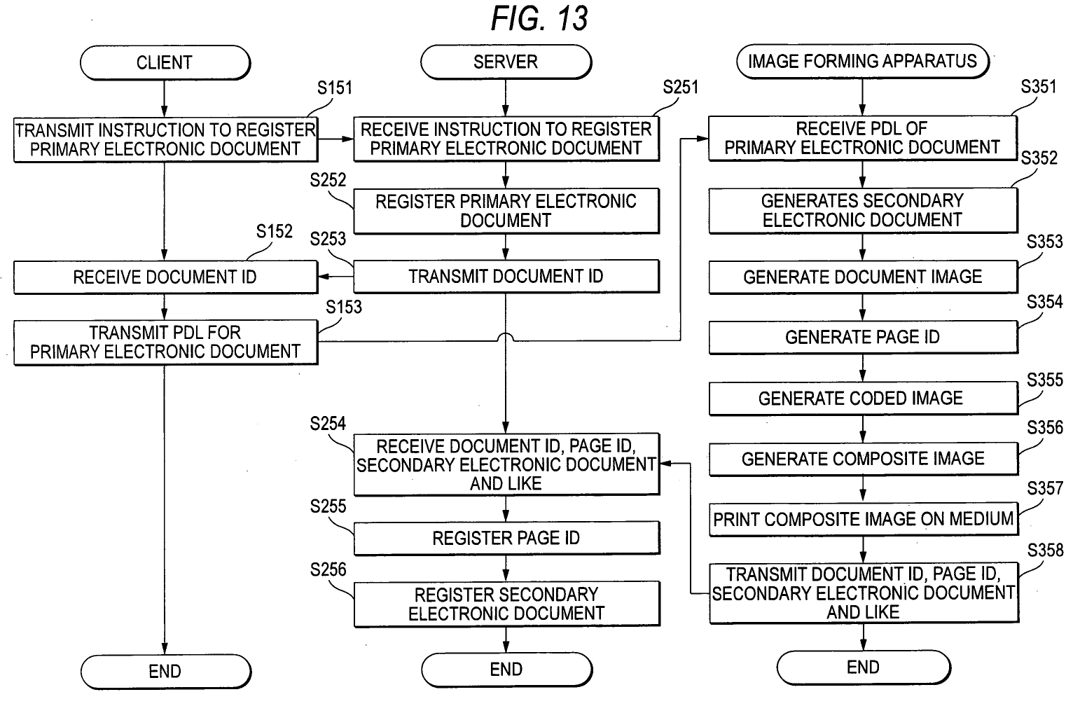

FIG. 13 is a flowchart which illustrates the operation of the system that occurs then.

Firstly, in step 151, steps 251 to 253 and step 152, although the client 10 inputs a primary electronic document into the server 20, since this process is the same as the process performed in step 101, step 201 to 203 and step 102 in FIG. 4, the detailed description thereof will be omitted here. Note that in this exemplary embodiment, too, as the primary electronic document, a text file which contains only characters, a document file prepared using document preparation software, and a file (PDF and the like) in which a document file is converted into a print format are raised.

Thereafter, the user operates the client 10 to issue an Instruction to print the primary electronic document.

When so operated, the client 10 transmits a PDL to print the primary electronic document to the image forming apparatus 30 (step 153). Note that the PDL contains the document ID that was received In step 152 as information which specifies the primary electronic document which the imaging forming apparatus 30 is instructed to print. In addition, the PDL also contains setting information regarding printing. Here, although the size and orientation of a sheet are contained in the setting information, in this exemplary embodiment, in particular, access authorization information to a secondary electronic document is also contained therein. This access authorization information may be such as to be inputted by the user or downloaded from other services available.

By this operation, the image forming apparatus 30 implements a process for printing the primary electronic document.

Namely, firstly, the reception unit 31 receives the PDL for the primary electronic document (step S351). Then, the reception unit 31 passes the PDL so received to the document generation unit 32 and passes the document ID and the setting information which are contained in the PDL to the page ID generation unit 34.

Then, the document generation unit 32 generates a secondary electronic document which reflects a print image of the primary electronic document from the PDL for the primary electronic document (step 352).

Here, the secondary electronic document can be generated as a format which limits change in print image of the primary electronic document. As the format of the secondary electronic document like this, the “XDW format” in the “DocuWorks” by Fuji Xerox Inc. and the “PDF format” in the “Acrobat” by Adobe Systems Inc. in the United States of America are raised.

Then, the document image generation unit 33 generates a document image of the primary electronic document based on the secondary electronic document generated by the document generation unit 32.

On the other hand, the page ID generation unit 34 generates a page ID (step 354).

Specifically speaking, the following process will be implemented.

Firstly, making an inquiry to the server 20, the page ID generation unit 34 obtains a current value M for a page ID which corresponds to the document ID passed thereto from the reception unit 31. Here, the current value M of the page ID means a maximum value of a page ID which was generated when the same document was printed previously, and the maximum value stored in a memory, not shown, is read out. In addition, the number N of page IDs which are necessary for printing this time is obtained. Then, an “M+N” is generated from the page IDs “M+1.” Note that in this case, the number of page IDs to be generated is determined in accordance with setting information. Namely, basically, a number of page IDs are generated which are equivalent to a number obtained by multiplying the number of pages to be printed by the number of copies to be printed. However, in the event that there exists an N-up designation in the setting information, the N-up designation also has to be taken into consideration. For example, in the event that 10 pages of an electronic document are printed five copies with a 2-up designation, 25 page IDs (=10÷2×5) are generated. Then, finally, the maximum value “M+N” of the page IDs generated this time is stored in the memory, not shown, so that it can be referred to next time page IDs are generated.

In the exemplary embodiment, the identification information of the medium is generated by combining the document ID and the page IDs in this way, and the page ID is counted up every time the same electronic document is printed.

Then, the page ID generation unit 34 passes the document ID and the setting information which it has received from the reception unit 31 and the page ID generated here to the coded image generation unit 35.

Then, the coded image generation unit 35 codes the document ID and the page ID which have been passed thereto from the page ID generation unit 34 so as to generate an identification code for a medium. In addition, the coded image generation unit 35 codes coordinates information prepared according to the setting information so as to generate a position code. Then, the coded image generation unit 35 images the identification code and the position code so as to generated a coded image (step 357). Following this, the compositing unit 36 combines the document image and the coded image together, so as to generated a composite image (step 356).

Then, the printing unit 300 outputs a print document 40 by printing the composite image on the medium using, for example, an electronic photography method (step 357). Note that as this occurs, the document image is formed using C (cyan), M (magenta) and Y (yellow) toners, while the coded image is formed using a special toner. Since the special toner has already been described above, the description thereof will be omitted here.

When printing is completed, the printing unit 300 informs the transmission unit 30 of the completion of printing, whereby the transmission unit 39 obtains the secondary electronic document from the document generation unit 32 and obtains the document ID, the page ID and access authorization information from the page ID generation unit 34. Then, the transmission unit 39 transmits them to the server 20 (step 358).

By this transmission, in the server 20, firstly, the reception unit 21 receives the document ID, the page ID, the secondary electronic document, and the access authorization information (step 254). Then, the reception unit 21 passes the document ID and the page ID to the page ID management unit 26 and passes the document ID, the secondary electronic document and the access authorization information to the secondary document management unit 24.

Then, the page ID management unit 26 registers the page ID in the management information storage unit 27 (step 255). Specifically speaking, the page ID management unit 26 stores the document ID passed thereto from the reception unit 21 and the page ID similarly passed thereto from the reception unit 21 in such a state that the document ID is related to the page ID.

In addition, the secondary document management unit 24 implements a process for registering the secondary electronic document passed thereto from the reception unit 21 (step 256).

To be specific, the following process will be implemented.

Firstly, the secondary document management unit 24 stores the secondary electronic document passed thereto from the reception unit 21 in the secondary document storage unit 25. As this occurs, the secondary document management unit 24 obtains information (for example, URL) on the storage location of the secondary electronic document in the secondary document storage unit 25. Then, the information on the storage location in the secondary document storage unit 25 is stored in the management information storage unit 27. As this occurs, however, the secondary document management unit 24 relates the information on the storage location of the secondary electronic document to those of the page IDs corresponding to the document ID passed from the reception unit 21 which have not yet been related to the secondary electronic document sequentially in the order of their increasing page ID values or from those with smaller ID values. Furthermore, as this occurs, the secondary electronic document is stored while being related to information on access authorization which is passed from the reception unit 21.

In addition, since code patterns based on which management information is generated in this exemplary embodiment and the coded image is generated in this exemplary embodiment and methods for generating them are identical to those described in FIGS. 5 to 7, the detailed description thereof will be omitted here.

Next, the operation performed in scanning a medium will be described.

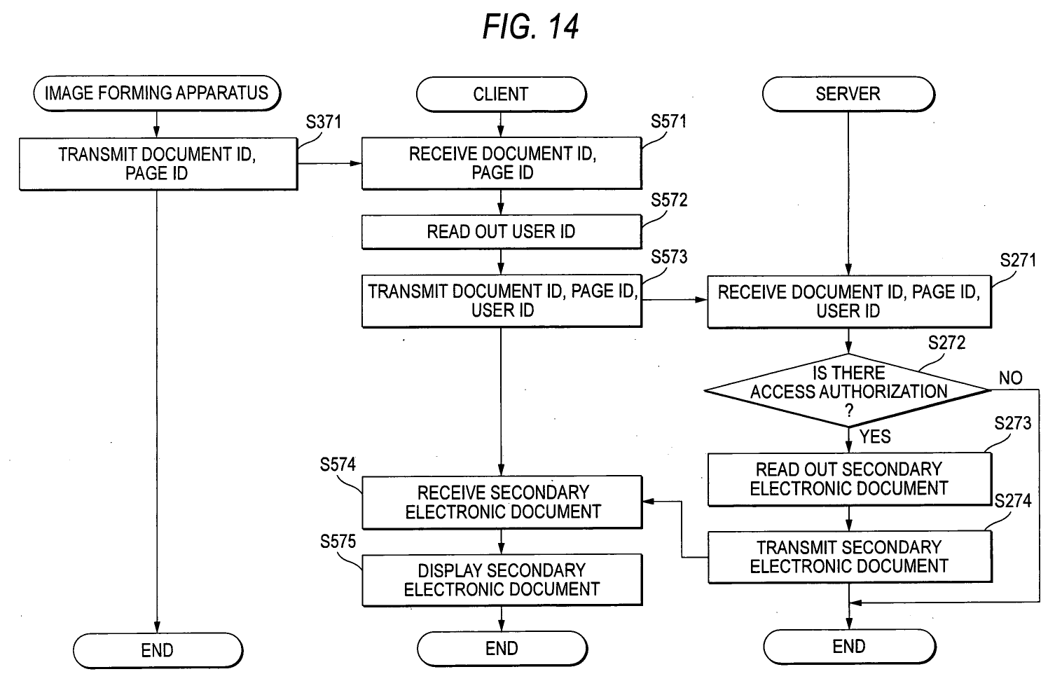

FIG. 14 is a flowchart which illustrates the operation of the system then.

The reading unit 37 of the image forming apparatus 30 reads a coded image from the print document 40. Then, the coded image analyzing unit 38 obtains the document ID and the page ID from the coded image. FIG. 14 shows the operation that will occur thereafter.

Firstly, in the image forming apparatus 30, the transmission unit 39 transmits the document ID and the page ID that the coded image analyzing unit 38 has obtained to the client 50 (step 371).

By this transmission, the client 50 receives the document ID, the page ID and the coordinates information (step 571). Then, the client 50 reads out a user ID of the user who is working thereon from its memory (step 572) and transmits the user ID so read out together with the document ID and the page ID to the server 20 (step 573). Note that the user ID is such as to be inputted into the client 50 when he or she starts working thereon so as to be stored in the memory within the client 50.

By this transmission, in the server 20, firstly, the reception unit 21 receives the document Id and the page ID and passes them to the secondary document management unit 23 (step 271).

Then, the secondary document management unit 24 refers to the access authorization corresponding to the combination of the document ID and the page ID in the management information storage unit 27. Then, the secondary document management unit 24 determines whether or not the user ID, which was passed thereto together with the document ID and the page ID, has the access authorization (seep 272). Note that the determination here is implemented, in the event that user IDs (for example, employee numbers) of users who can access secondary electronic documents are described as the access authorization, by comparing the user ID passed thereto from the reception unit 21 directly with the user IDs in the access authorization. In addition, in the event that titles and names of groups to which users belong who are allowed to access secondary electronic documents are described as the access authorization, the determination is made through the following process. Namely, firstly, a title and a name of the group to which the user belongs whose user ID was passed from the reception unit 21 are obtained based on a data base prepared separately. Then, the title and the name of the group of the user so obtained are compared with the titles and the names of groups in the access authorization.

Here, if the user ID passed from the reception unit 21 has the access authorization, the secondary document management unit 24 refers to the management information storage unit 27 so as to obtain information on the memory location of the secondary electronic document. Then, using the information so obtained, the secondary document management unit 24 reads out the secondary electronic document from the secondary document storage unit 25 and passes it to the transmission unit 29 (step 273).

On the other hand, if the user ID passed from the reception unit 21 has no access authorization, although not shown, the transmission unit 29 transmits, for example, an error message to the client 50 and ends the process.

Then, the transmission unit 29 transmits the secondary electronic document to the client 50 (step 274).

By this transmission, the client 50 receives the secondary electronic document (step 574).

Then, the client 50 displays the secondary electronic document so received on a display (step 575).

Thus, the operation of this exemplary embodiment ends.

Note that while in this exemplary embodiment, the page IDs are generated in the image forming apparatus 30, a configuration may be adopted in which page IDs are generated in the client 10, so as to be transmitted to the image forming apparatus 30.

In addition, while in the aforesaid exemplary embodiment, the combination of the document ID and the page ID is assumed as the medium identification information, the invention is not limited thereto.

Namely, by combining information which specifies the image forming apparatus 30 and information which specifies individually the print instructions of the print instructions by the image forming apparatus 30, medium identification information may be made to be generated. Alternatively, in the event that the medium identification information is generated in the client 10, by combining information which specifies the client 10 and information which specifies individually the print instructions of the print instructions by the client 10, medium identification information may be made to be generated. Here, as the information which specifies the individual print outputs or individual print instructions, for example, the order of print outputs or print instructions or times of print outputs or print instructions can be considered.

In addition, the identification information of the medium may not have to be continuous values or significant value, and hence, a value generated as a random number or a value generated as a separate UUID may be used as the medium identification information. Namely, the medium identification information may be a so-called sheet ID which enables the trace of a page which corresponds to the secondary electronic document without knowing the document ID thereof.

Furthermore, the exemplary embodiment has been described on the premise of transmitting the secondary electronic document to the client 50 for display.

However, it may be configured such that not the secondary electronic document itself but the information on the memory location of the secondary electronic document is transmitted to the client 50. In this case, the client 50 is made to obtain the secondary electronic document based on the information on the memory location thereof. Alternatively, it may be configured such that the setting information for generating a secondary electronic document is transmitted to the client 50. In this case, the client 50 is made to generate a secondary electronic document based on the setting information.

### Third Exemplary Embodiment

In this exemplary embodiment, a primary electronic document is printed from the client 10. In addition, at least a document ID of the primary electronic document, a secondary electronic document, and a page ID (of a sheet ID) of the secondary electronic document are generated on the client 10. Additionally, the client 10 converts the document ID, the page Id and position information into a coded image, superposes a print image of the primary electronic document the coded image so generated and transmits them to the image forming apparatus 30. Furthermore, in parallel with this operation, the client 10 transmits the primary electronic document, the secondary electronic document, the document ID and the page ID (the sheet ID) to the server 20 in such a manner that they are related to each other.

Note that in the event that the client 10 in this exemplary embodiment is taken as an identification information generation unit, the configuration thereof will be described as below.

Namely, there is provided a first identification information generation unit which includes an image transmitting unit that transmits a primary electronic document image to an image forming apparatus for forming an image on a medium, a generation unit that generates identification information which specifies the medium and a transmission unit that transmits the identification information generated by the generation unit and information which obtains a secondary electronic document which can reproduce an image shape of the primary electronic document on the medium to one other unit in such a manner that those pieces of information are related to each other.

In addition, there is provided a second identification information generation unit according to the first identification information generation unit, wherein the generation unit generates the identification information by combining information which specifies the primary electronic document and information which specifies individual media of a plurality of media on which an image of the primary electronic document is formed.

Furthermore, there is provided a third identification information generation unit according to the first identification information generation unit, wherein the generation unit generates the identification information by combining information which specifies the image forming apparatus for forming an image and information which specifies individual media of a plurality of media on which an image is formed by the image forming apparatus.

In addition, there is provided a fourth identification information generation unit according to the first identification information unit, wherein the image forming apparatus forms further an image which represents the identification information on the medium.

Furthermore, there is provided a fifth identification information generation unit according to the first identification information generation unit, which includes further an obtaining unit that obtains characteristic information which is specific to individual media, wherein the transmission unit transmits the identification information generated by the generation unit and the characteristic information obtained by the obtaining unit to the one other unit in such a manner that those pieces of information are related to each other.

Incidentally, the print information management unit which stores a medium, a primary electronic document and a secondary electronic document in such a state that they are related to each other can be realized by some of the constituent components which constitute the configuration of the system shown in FIG. 1. Then, assuming that the unit is realized by a general computer 90, a hardware configuration of the computer 90 will be described.

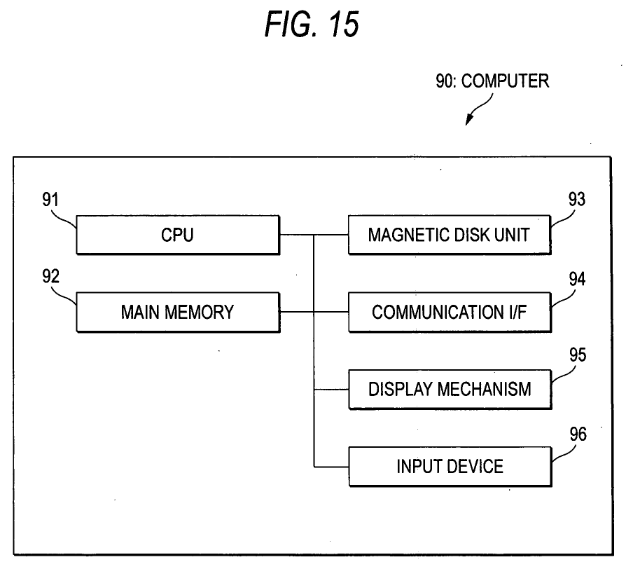

FIG. 15 is a diagram which shows a hardware configuration of the computer 90.

As is shown in the figure, the computer 90 includes a CPU (Central Processing Unit) which is an operation unit, a main memory 92 and a magnetic disk unit (HDD: Hard Disk Drive) 93, the latter two devices constituting a storage unit. Here, the CPU 91 executes various software such as an OS (Operating System) and an application and realizes the aforesaid functions. In addition, the main memory 90 constitutes a storage area for storing the various software and data for use in executing the software, and the magnetic disk unit 93 is a storage area for storing input data to the various software and output data from the various software.

Furthermore, the computer 90 includes a communication I/F 94 for establishing a communication with an external device, a display mechanism 95 which is made up of a video memory, a display and the like and an input device 96 such as a keyboard, a mouse and the like.

Thus, the description of the exemplary embodiment ends.

Note that in the exemplary embodiment, the secondary electronic document is designed to be printed in the same layout as that in which the primary electronic document is printed. However, totally the same layouts do not have to be used. Even though there exists a slight difference between the layout used when the primary electronic document is printed and the layout used when the secondary electronic document is printed, the difference may be acceptable, provided that any complex conversion process attributed to the difference is not involved when the user implements writing on the medium.

Furthermore, while in the exemplary embodiment, the access authorization to the secondary electronic document is described, this access authorization can be taken as control information which controls the utilization of the secondary electronic document.

In addition, while in the exemplary embodiment, the information is applied to the medium by printing the coded image in which the information is coded and image, the method for applying the information to the medium is not limited thereto. For example, methods such as Trust Marking Basic, QR code, footer printing of UUID can be used for application of the information to the medium.

Furthermore, while in the exemplary embodiment, the information is configured so as to be embedded in the medium, in the event that information is embedded in the medium, it is considered that the information so embedded is used. Here, as information which has already been embedded in the medium, for example, a QR code printed on a medium and fiber information which is specific to a medium are raised. A configuration may be adopted in which the information is extracted as characteristic information of the medium, so as to be related to the identification information of the medium.

In addition, although nothing is mentioned about a process after the output of the print document 40, the image forming apparatus 30 may be configured so as to transmit the information that has been completely outputted to the server 20. Here, the information that has been completely outputted may take the form of a signal which simply signals the completion or an image of what is actually printed on the medium and a job log then.

Note that in the exemplary embodiment, as has been described before, the identification information can be made up of the combination of the information which specifies the primary electronic document and the information which specifies the individual media of the plurality of media on which the primary electronic document is printed. Then, by such a configuration, there is provided an advantage that the medium can be identified based on the information on the electronic document.

In addition, the exemplary embodiment can be taken as a print information management unit which includes a storage unit that stores identification information which specifies a medium on which a primary electronic document is printed and information which obtains a secondary electronic document which can reproduce an image shape of the primary electronic document on the medium in such a manner that those pieces of information are related to each other, a reception unit that receives the identification information from one other unit, and a processing unit that enables the utilization of the secondary electronic document on the one other unit by utilizing the information which obtains the secondary electronic document which is stored in relation to the identification information received by the reception unit. Then, by the configuration like this, there is provided an advantage that the secondary electronic document can be made use of by utilizing the information in which the identification information is related to the secondary electronic document.

Note that a program which realizes the exemplary embodiment can be provided by not only a communication unit but also a recording medium such as a CD-ROM.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A print information management apparatus comprising:
a generation unit that generates print information, in which identification information that uniquely specifies a medium on which a primary electronic document is printed is related to a secondary electronic document that can reproduce an image shape of the primary electronic document on the medium; and
a storage unit that stores the print information generated by the generation unit.

2. A print information management apparatus comprising:
a generation unit that generates print information in which document information allocated to identify a primary electronic information, a name of the primary electronic document, information indicating a storage location of the primary electronic document, page information that is allocated to identify individual media of a plurality of media on which the primary electronic document is printed, information indicating a storage location of a secondary electronic document that can reproduce an image shape of the primary electronic document on the medium, information regarding access authorization to the secondary electronic document and information regarding history of operation of the secondary electronic document are made equivalent to each other; and
a storage unit that stores the print information generated by the generation unit.

3. An image forming apparatus comprising:
a forming unit that forms an image of a primary electronic document and an image representing identification information that uniquely specifies a medium on the medium; and
a generation unit that generates print information in which the identification information is related to information for obtaining a secondary electronic document that can reproduce an image shape of the primary electronic document on the medium.

4. The image forming apparatus according to claim 3,
wherein the identification information comprises a combination of information that identifies a subject apparatus and information that specifies individual media of a plurality of media on which an image is formed by the subject apparatus.

5. The image forming apparatus according to claim 3,
wherein the forming unit forms a coded image in which an identification code obtained by coding the identification information is imaged using an invisible image forming material having an absorption wavelength in a substantially infrared area.

6. The image forming apparatus according to claim 3, which further comprises an obtaining unit that obtains characteristic information specific to individual media,
wherein the generation unit generates further information in which the identification information is related to the characteristic information obtained by the obtaining unit.

7. A print information management system comprising:
a designation unit that designates a printing of a primary electronic document;
a printing unit that prints on a medium the primary electronic document and identification information that uniquely specifies the medium in response to designation by the designation unit;
a storage unit that stores print information in which the identification information is related to a secondary electronic document that can reproduce an image shape of the primary electronic document on the medium;
a reading unit that reads the identification information printed on the medium; and
an obtaining unit that obtains the secondary electronic document that is related to the identification information read by the reading unit in the print information.

8. A computer readable medium storing a program causing a computer to execute a process for managing print information, the process comprising:
generating print information in which identification information that uniquely specifies a medium on which a primary electronic document is printed is related to a secondary electronic document that can reproduce an image shape of the primary electronic document on the medium; and
storing the generated print information in a predetermined storage device.

9. A computer data signal embodied in a carrier wave for enabling a computer to perform a process for managing print information, the process comprising:
generating print information in which identification information that uniquely specifies a medium on which a primary electronic document is printed is related to a secondary electronic document that can reproduce an image shape of the primary electronic document on the medium; and
storing the generated print information in a predetermined storage device.

10. A print information management method comprising:
generating print information in which identification information that uniquely specifies a medium on which a primary electronic document is printed is related to a secondary electronic document that can reproduce an image shape of the primary electronic document on the medium; and
storing the print information generated by the generation unit.
